(19) United States
(12) Patent Application Publication
(10) Pub. No.: US 2026/0050626 A1
(43) Pub. Date: Feb. 19, 2026

(54) Ranked Reciprocal Mutuality as a Precision Mechanism for Large Sets of Similarities

(71) Applicant: ORACLE INTERNATIONAL CORPORATION, Redwood Shores, CA (US)

(72) Inventors: Stuart Joseph LAWSON, Timsbury (GB); Anton BOUGAEV, La Jolla, CA (US); Constantine Lefteri TSOUKALAS, Lafayette, IN (US)

(21) Appl. No.: 18/802,709

(22) Filed: Aug. 13, 2024

(51) Int. Cl. G06F 16/383; G06F 16/33; G06F 40/205

(52) U.S. Cl. CPC G06F 16/383; G06F 16/3347

(57) ABSTRACT

Systems, methods, and other embodiments associated with use of ranked reciprocal mutuality as a precision mechanism for sets of similarities. In one example embodiment, a method includes accessing a source dataset that includes a plurality of source artefacts and a target dataset that includes a plurality of target artefacts. The method may generate, for pairings of the source artefacts with the target artefacts, ranked reciprocal mutuality scores that quantify precision of an individual pairing of a source artefact and a target artefact. The ranked reciprocal mutuality scores are generated based on similarity scores for the pairings. The method may discard the pairings that have a ranked reciprocal mutuality score that exceeds a threshold. And, the method may generate an electronic alert that indicates the remaining pairings to be most equivalent matches.

### BACKGROUND

Computing systems may determine whether two data artefacts match each other. Similarity score between paired data artefacts alone presents incomplete information as to whether the pair of data artefacts are relevant or equivalent matches. A measure of precision (that is, of mutuality of the similarity) can provide additional context for the match with reference to other available matches.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an RRM precision system that is associated with use of ranked reciprocal mutuality (RRM) as a precision mechanism for sets of similarities.

FIG. 2 illustrates one embodiment of an RRM precision method that is associated with use of RRM as a precision mechanism for sets of similarities.

FIG. 3 illustrates one embodiment of an RRM scoring method for generation of RRM scores, and which is associated with use of ranked reciprocal mutuality as a precision mechanism for sets of similarities.

FIG. 4 illustrates one example of results of applying an RRM precision method to two datasets.

FIG. 5 illustrates an embodiment of a computing system configured with the example systems and/or methods disclosed.

### DETAILED DESCRIPTION

Systems, methods, and other embodiments are described herein that use ranked reciprocal mutuality as a precision mechanism for sets of similarities. In one embodiment, a ranked reciprocal mutuality (RRM) precision system is configured to determine a score or value for a novel measure of precision (or equivalence) between matches that considers the mutual similarity of entities in the context of possible matches. The novel measure of precision, referred to herein as a RRM score or sigma score, quantifies an extent to which rank of similarity between a pair of artefacts is reciprocated. The novel RRM score is generated efficiently and simply by an additive combination of the ranks of similarity of the pairing for each artefact in the pair among other available pairings. The RRM score may then be used to filter or otherwise reduce pairings of interest to those where the paired artefacts are mutually more like each other than to other artefacts. This serves to isolate the more precise, more relevant pairings from those which are only superficially similar based on context of similarity for alternative pairings.

Existing methods for evaluating precision (equivalence or mutual similarity) of matches in the context of other possible matches employ complex calculations that become impracticable for even moderately sized datasets. For example, some measures of precision employ calculation of harmonic mean or geometric mean between ranks of entities in each other's similarity lists. Other measures of precision compute and aggregate overlap between the ranked similarity lists, while still others compute mutual information between the ranked similarity lists. In one embodiment, the ranked reciprocal mutuality (RRM) precision systems and methods disclosed herein improve dramatically over the available technologies for determining precision of a match by employing only basic arithmetic and logical operations (such as addition, subtraction, logical AND, OR, and NOT, and simple sorting) to quantify the precision from similarity information. Thus, for example, the substantial improvement to performance over existing precision measures allows evaluation of match precision to be performed for much larger datasets without resorting to additional compute resources such as processors and memory. In short, the processing requirements and/or memory usage of the underlying computing systems is reduced over prior solutions while still providing accurate measures of precision (mutuality of similarity or equivalence). This improvement in efficiency makes it possible for a given computing system to evaluate precision matches for far larger datasets than would otherwise be possible using the given computing system.

In one embodiment, the RRM precision system generates ranked reciprocal mutuality scores for pairings of artefacts by combining the two ranks (in terms or similarity value) of the pairing among (1) the available pairings for the first artefact in the pair, and (2) the available pairings for the second artefact in the pair. Those pairings of artefacts that satisfy a threshold for their corresponding ranked reciprocal mutuality score are retained as sufficiently precise or equivalent pairings, while pairings that do not satisfy the threshold are filtered out. The retained pairings may then be provided to other systems as matches. In this way, matches in which the artefacts are only superficially similar are removed, thereby reducing the potential matches to a more relevant subset.

### Definitions

As used herein, the term “ranked reciprocal mutuality” refers to a novel metric provided herein for quantifying precision of matches between embedded artefacts using similarity scores for the matches. In one embodiment, ranked reciprocal mutuality describes the precision of a match or pairing between artefacts a and b based on the respective ranks, in order of similarity score, of (i) the pairing of artefacts a and b among pairings of artefact a with available artefacts other than b (alpha score), and (ii) the pairing of artefacts a and b among pairings of artefact b with available artefacts other than a (beta score). In one embodiment, ranked reciprocal mutuality between artefacts a and b is quantified in a single value that combines the alpha score and beta score, referred to herein as a “mutual-reciprocal score”, “ranked reciprocal mutuality score”, or “sigma score” for the pairing. For example, the mutual-reciprocal score may combine the alpha and beta scores as follows: σ=α+β−1. In one embodiment, the mutual-reciprocal score may be generated as described below under the headings “Example RRM Precision Method Using Pre-Computed Similarities” and “Example RRM Precision Method Using Nearest-Neighbor Search”.

As used herein, the term “artefact” refers to an item, object, data point, node, record, observation, or other entity that serves as a unit of data within a dataset. In one embodiment, an artefact is uniquely identifiable within the dataset (for example using a unique identifier or key), and includes attributes or features that quantitatively or qualitatively describe properties or characteristics of the artefact. For example, an artefact may be an individual record or row of a database, log entry of a cloud system, unit of text (such as a document, paragraph, sentence, token) within a larger collection of text, an individual image within a collection of images, node of a graph, audio file, video file, and so forth.

As used herein with reference to a given artefact, the term a “similarity” or one or more “similarities” refers to a data structure that both (1) associates another artefact with the given artefact and (2) quantifies an extent to which the given artefact and the other artefact are similar. For example, a similarity may be a tuple or other data structure that is stored in association with a given artefact and which includes a unique identifier for the other artefact and a similarity score that quantifies how closely the data artefacts resemble each other. Numerical values for similarity associated with particular pairs of artefacts may be referred to herein simply as “similarities”.

As used herein in the context of artefact comparison, the term “similarity” refers to a measure of the extent to which a pair of artefacts are similar.

As used herein in the context of artefact comparison, the terms “precision” and “reciprocity” refer to a measure of the extent to which a pair of artefacts are equivalent, or mutually similar to each other in context of other possible pairings. Note that the term “precision” as used herein refers to a measure of mutuality of similarity between artefacts, and does not refer to a measure of how accurately a similarity analysis identifies relevant items, such as TruePositives/(TruePositives+FalsePositives).

It should be understood that no action or function described or claimed herein is performed by the human mind. No action or function described or claimed herein can be practically performed in the human mind. Any interpretation that any action or function described or claimed herein can be performed in the human mind is inconsistent with and contrary to this disclosure.

### —Example RRM Precision System—

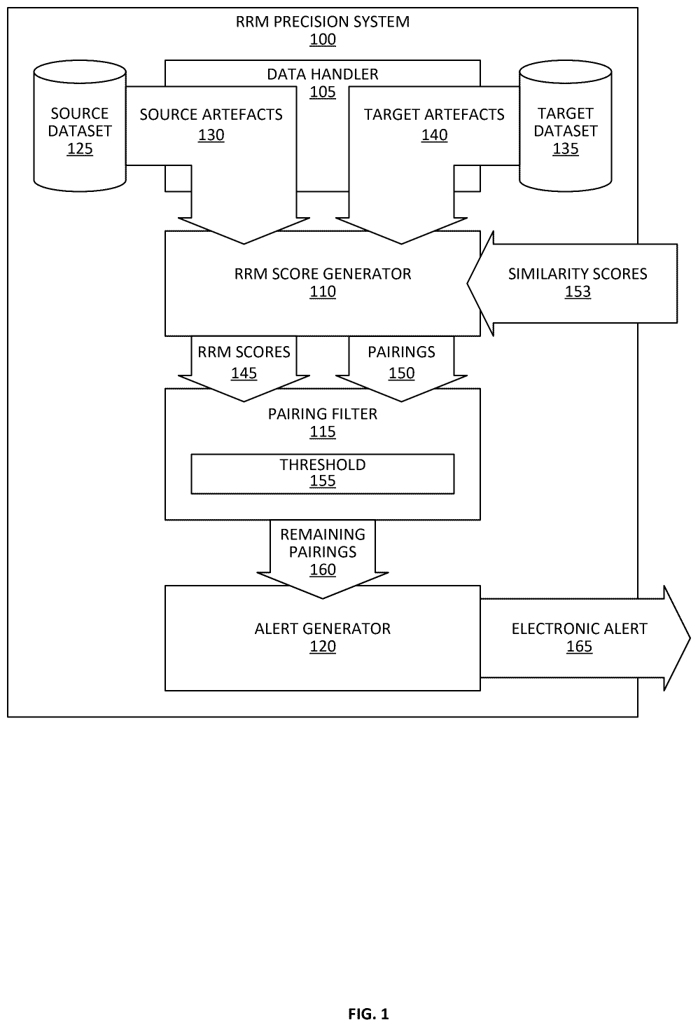

FIG. 1 illustrates one embodiment of an RRM precision system 100 that is associated with use of ranked reciprocal mutuality (RRM) as a precision mechanism for sets of similarities. RRM precision system 100 includes components configured for determining ranks of similarity for an artefact match (or pairing) among other candidate artefact matches, and using the ranks of similarity to express a value of precision for the artefact match. In one embodiment, RRM precision system 100 includes a data handler 105, an RRM score generator 110, a pairing filter 115, and an alert generator 120. In one embodiment, the components of RRM precision system 100 intercommunicate to provide data or results to one another, for example by electronic messages as discussed below under the heading “Cloud or Enterprise Embodiments”.

In one embodiment, data handler 105 is configured to access a source dataset 125 that includes a plurality of source artefacts 130 and a target dataset 135 that includes a plurality of target artefacts 140. For example, data handler 105 is configured to establish connections to one or more databases that include source dataset 125 and target dataset 135, compose and execute a query to the connected database(s) that specifies retrieval of the source dataset 125 and target dataset 135, fetch the source dataset 125 and target dataset 135 returned by the database, and provide the source artefacts 130 from source dataset 125 and target artefacts 140 from target dataset 135 to RRM score generator 110 and/or other downstream components.

In one embodiment, RRM score generator 110 is configured to generate ranked reciprocal mutuality scores 145 that quantify precision of an individual pairing 150 of a source artefact 130 and a target artefact 140. In one embodiment, RRM score generator 110 is configured to generate the ranked reciprocal mutuality scores 145 for a plurality of pairings 150 of the source artefacts with the target artefacts. The RRM score generator 110 is configured to generate the ranked reciprocal mutuality scores 145 based on similarity scores 153 for the pairings 150. In one embodiment, the RRM score generator 110 is configured to generate individual ranked reciprocal mutuality scores 145 based on both (A) similarity scores 153 that correspond to the pairings 150 of one source artefact am with one target artefact bn and other target artefacts (e.g., b1-bn−1, bn+1-bN for pairings with all target artefacts, or bk₁-bk_{K} for pairings with a top K target artefacts) and (B) similarity scores 153 that correspond to the pairings of the one target artefact bn with the one source artefact am and other source artefacts (e.g., a1-am−1, am+1-aM for pairings with all source artefacts, or ak₁-ak_{K} for pairings with a top K source artefacts).

In one embodiment, pairing filter 115 is configured to discard the pairings 150 that have a ranked reciprocal mutuality score 145 that exceeds a threshold 155. In one embodiment, pairing filter 115 is configured to select one particular one of the pairings 150 of source artefacts 130 and target artefacts 140 to be a best match over others of the pairings 150. In this case, threshold 155 is a condition that the remaining pairing(s) 160 after filtering is the one pairing that has the highest precedence (i.e., lowest) RRM score 145. Thus, the pairing filter 115 bases the selection of the remaining pairing(s) 160 on the ranked reciprocal mutuality score 145 indicating that the pairing has greater precision than other pairings that have similarity scores greater than a similarity score of the pairing. In one embodiment, pairing filter 115 is configured to retain a few top match pairings that have highest precedences (i.e., lowest) RRM scores 145 as the remaining pairings 160 after the filtering. Thus, for example, the threshold may be a count of the number of matches to be retained. Or, for example, the threshold may be a maximum or cap on the RRM score 145 for matches. Where the threshold is a cap on RRM score 145, it is possible that no matches will be retained in the remaining pairings.

In one embodiment, alert generator 120 is configured to generate an electronic alert 165 that indicates the remaining pairings 160 to be most equivalent matches. In one embodiment, alert generator 120 is configured to generate an electronic alert 165 that indicates one particular pairing (i.e. where a single pairing is retained) to be a best match or the most equivalent match. In one embodiment, alert generator is configured to compose an electronic message with the remaining pairing(s) 160 that are the best/most equivalent match(es), for example by populating a template electronic message with the relevant information. Optionally, alert generator 120 is configured to compose the electronic message to include other relevant information such as identification of the source dataset 125 and target dataset, similarity score(s) 153 and RRM score(s) 145 that correspond to the remaining pairing(s) 160. Alert generator 120 then accesses electronic addresses for the recipients of the alert, such as addresses of other components of a larger matching system that further processes the remaining pairings 160, email or other messaging addresses associated with administrators and users of the RRM precision system 100, one or more system logs, or addresses of user interfaces such as a graphical user interface (GUI) or command line interface (CLI). Once the electronic alert 165 is composed, alert generator 120 is configured to transmit the electronic alert 165 to the recipients. In one embodiment, alert generator 120 is configured to transmit the electronic alert 165 through a variety of notification, streaming, queue, or other messaging services.

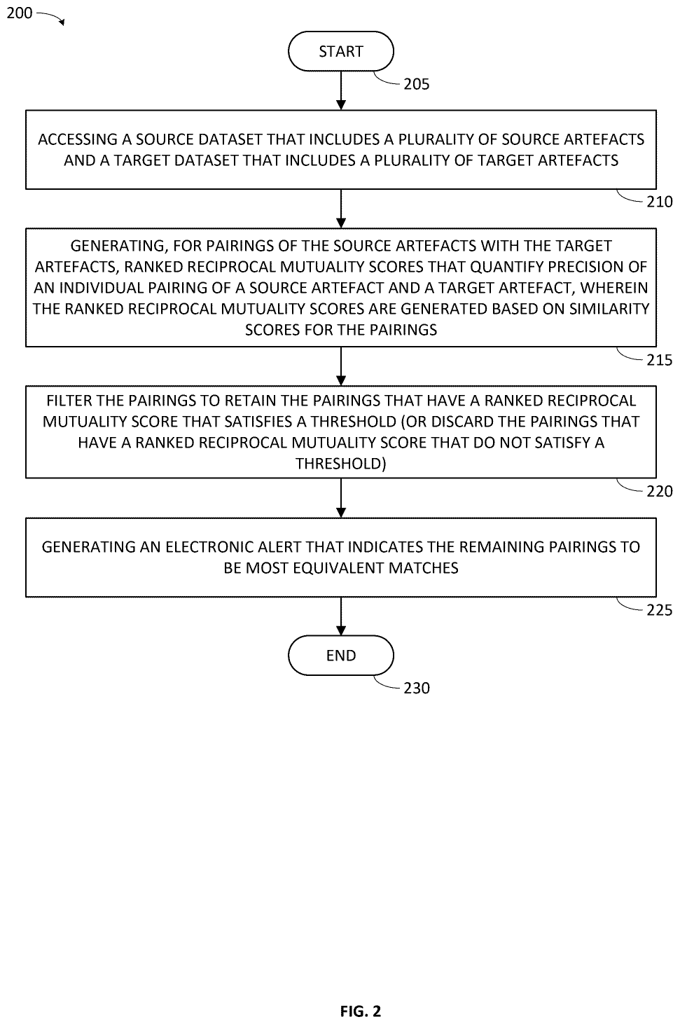

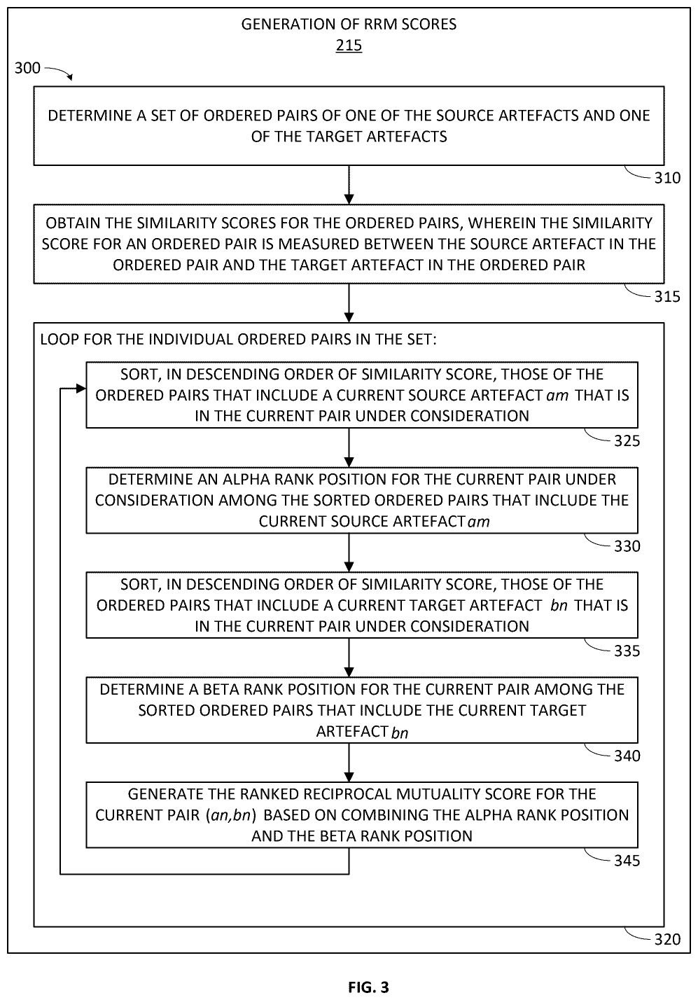

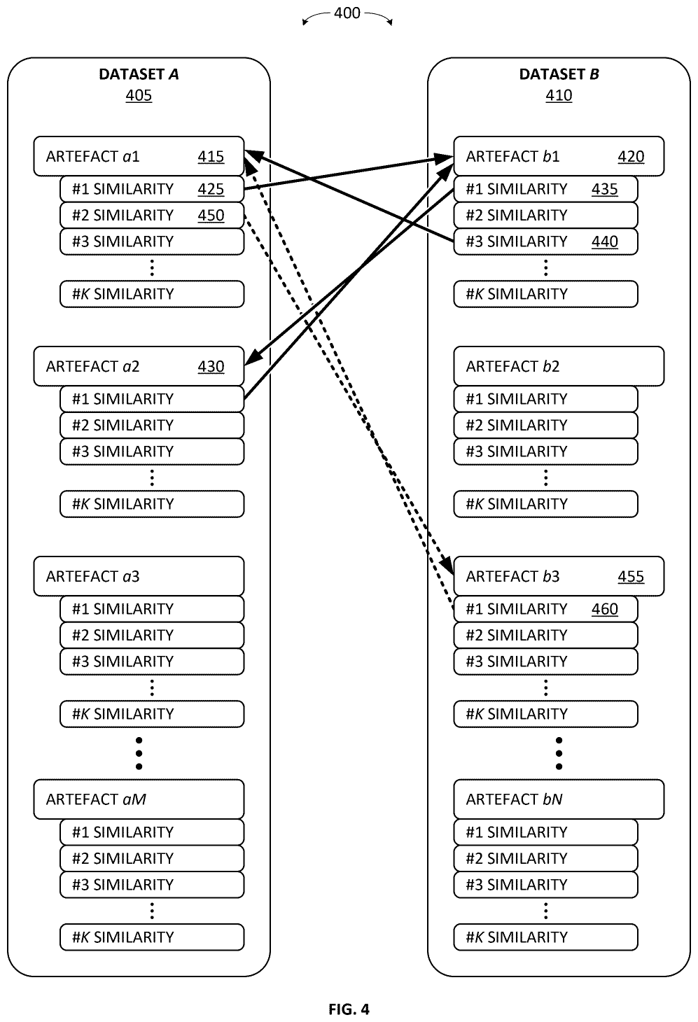

Further details regarding RRM precision system 100 are presented herein. In one embodiment, operations of RRM precision system 100 will be described with reference to example RRM precision method 200 of FIG. 2 and RRM scoring method 300 of FIG. 3. In one embodiment, a diagram showing an example application of the RRM precision system 100 to two example datasets will be described with reference to FIG. 4.

### —Example RRM Precision Method—

FIG. 2 illustrates one embodiment of an RRM precision method 200 that is associated with use of ranked reciprocal mutuality (RRM) as a precision mechanism for sets of similarities. RRM precision method 200 is one example process for quantifying the extent of precision (equivalence or exactness) of pairings or matches between data artefacts.

In one embodiment, as a general overview, RRM precision method 200 initially accesses a source dataset to obtain source artefacts and accesses a target dataset to obtain target artefacts. For pairings of individual source and target artefacts, RRM precision method 200 generates ranked reciprocal mutuality scores based on similarity scores for the pairings. For example, the ranked reciprocal mutuality scores combine similarity ranks of the pairing with respect to the other pairings available to each entity in the pairing into a single value. RRM precision method 200 then filters the pairings to keep the pairings that have a ranked reciprocal mutuality score that satisfies a threshold for precision of the pairing, and remove the pairings that have a ranked reciprocal mutuality score that fails to satisfy the threshold. The RRM precision method 200 then generates one or more electronic alerts to provide the pairings that satisfied the threshold to other, downstream processes.

In one embodiment RRM precision method 200 initiates at START block 205 in response to RRM precision system 100 determining one or more of (1) RRM precision system 100 has been instructed to determine one or more best matches between a source dataset and a target dataset; (2) that an instruction to perform RRM precision method 200 has been received; (3) a user or administrator has initiated RRM precision method 200; (4) it is currently a time at which RRM precision method 200 is scheduled to be run; or (5) RRM precision method 200 should commence in response to satisfaction of some other condition. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of RRM precision system 100 executes RRM precision method 200. In one embodiment, at START block 205, RRM precision method 200 (i) configures the computing system with system settings, software dependencies and libraries, and modules for the components of RRM precision system 100; (ii) connects to data sources (such as databases, data stores, file systems, and cloud storage) and fetches datasets used by the RRM precision method 200, such as source dataset 125 and target dataset 135 or pre-calculated similarity scores 153 between cross-dataset pairings of artefacts; and (iii) allocates and initializes resources used by RRM precision method 200, such as processor, memory, storage, and network connections. Following initiation at START block 205, RRM precision method 200 proceeds to block 210.

At block 210, RRM precision method 200 accesses a source dataset that includes a plurality of source artefacts and a target dataset that includes a plurality of target artefacts. For example, RRM precision method 200 loads and executes a query that reads the source dataset and target dataset from a datastore.

In one embodiment, RRM precision method 200 operates on two separate datasets: a source dataset, and a target dataset. The source dataset and target dataset each include multiple data entities or items, referred to herein as “artefacts.” Artefacts belonging to the source dataset may be referred to herein as “source artefacts, and artefacts belonging to the target dataset may be referred to herein as “target artefacts.” In general, the artefacts are embedded representations of various types of data object, such as texts, images, audio files, or any other structured data that have been converted into numerical vectors using embedding models.

In one embodiment, the source and target datasets are specified by a client software application or user of the RRM precision method 200. In one embodiment, at block 210 the system accepts as inputs (i) parameters for connecting to data sources (such as source dataset and target dataset), (ii) obtains or retrieves artefacts (such as source and target artefacts) from the data sources, and (iii) makes the retrieved artefacts available to downstream processes.

In one embodiment, the steps of block 210 are performed by data handler 105. At the conclusion of block 210, RRM precision method 200 has produced as outputs the source and target datasets. RRM precision method 200 will use the source and target datasets to perform similarity comparisons. Processing continues to block 215.

At block 215, RRM precision method 200 generates ranked reciprocal mutuality (RRM) scores that quantify precision of an individual pairing of a source artefact and a target artefact. In one embodiment, RRM precision method generates the ranked reciprocal mutuality scores for multiple pairings of the source artefacts with the target artefacts. The ranked reciprocal mutuality scores are generated based on similarity scores for the pairings. For example, the ranked reciprocal mutuality score is generated based on both (A) similarity scores for pairings of the source artefact with the target artefact and other target artefacts and (B) similarity scores for pairings of the target artefact with the source artefact and other source artefacts. In other words, at block 215 the RRM precision method 200 employs similarity scores to assess the precision of various source-target artefact pairings, as described herein.

Referring to FIG. 3, FIG. 3 illustrates one embodiment of a RRM scoring method 300 for generating the ranked reciprocal mutuality scores (and which is associated with use of ranked reciprocal mutuality as a precision mechanism for sets of similarities). RRM scoring method 300 is one example implementation of functions of block 215. In one embodiment, to generate the ranked reciprocal mutuality scores, at block 310, RRM scoring method 300 determines a set of ordered pairs of one of the source artefacts and one of the target artefacts, such as all unique pairings of the source artefacts and the target artefacts. Then, at block 315, RRM scoring method 300 generates, loads, or otherwise obtains the similarity scores for the ordered pairs. RRM scoring method 300 then executes a loop at block 320, iterating through the following steps for each pair in the set of ordered pairs of source and target artefact.
(1) At block 325, RRM scoring method 300 sorts ordered pairs that include the source artefact am that is in the current pair. The sorted ordered pairs leave out or exclude ordered pairs that do not include the source artefact am. The ordered pairs that include the source artefact am are sorted in descending order of similarity score between am and the target artefacts b1-bN.
(2) At block 330, RRM scoring method 300 determines a rank position for the current pair among the sorted pairs that include the source artefact am. The rank position—that is, the placement, standing, or count, in sorted order, of the pairings beginning with the most similar—is also referred to herein as an alpha rank or alpha score.
(3) At block 335, RRM scoring method 300 also sorts ordered pairs that include the target artefact bn that is in the current pair. The sorted ordered pairs leave out or exclude ordered pairs that do not include the target artefact bn. The ordered pairs that include the target artefact bn are sorted in descending order of similarity score between the source artefacts a1-aM and the current target artefact bn.
(4) At block 340, RRM scoring method 300 determines a rank position for the current pair among the sorted pairs that include the target artefact bn. The rank position here is also referred to herein as a beta rank or beta score.
(5) At block 345, RRM scoring method 300 generates the ranked reciprocal mutuality score (also referred to herein as the sigma score) for the current pair. The sigma score is generated based on combining the alpha rank position and the beta rank position. For example, the alpha score and beta scores are summed, and then offset by −1 to combine them into the sigma score, as discussed below.

In one embodiment, all pairings with a given artefact are considered by the RRM scoring method 300 in the steps above. In one embodiment less than all pairings with a given artefact are considered by the RRM scoring method 300 in the steps above. For example, the RRM scoring method 300 considers a subset of K pairings that are top-ranked in terms of similarity score.

In one embodiment, RRM scoring method 300 determines a top K target artefacts in the target database. The top K target artefacts are the K target artefacts bk₁-bk_{K} that are most similar to the source artefact am, and which will therefore have greatest primacy in alpha rank. Accordingly, in one embodiment, at block 330 above, RRM scoring method 300 generates the alpha ranks based on the similarity scores for the various individual pairings of source artefact am with the K target artefacts bk₁-bk_{K}. The RRM scoring method 300 determines a further top K source artefacts in the source database. The top K source artefacts are the K source artefacts ak₁-ak_{K} that are most similar to the target artefact bn, and which will therefore have greatest primacy in beta rank. The RRM scoring method 300 generates alpha ranks based on the similarity scores for the various individual pairings of source artefact am with the K target artefacts bk₁-bk_{K}. Accordingly, in one embodiment, at block 340 above, RRM scoring method 300 generates the beta ranks based on the similarity scores for the various individual pairings of the K source artefacts ak₁-ak_{K} with target artefact bn. As discussed above at block 345, RRM scoring method 300 combines the alpha rank and the beta rank for each individual pairing (am,bn) to generate the ranked reciprocal mutuality score (sigma score) for the individual pairing.

Referring again to FIG. 2, at block 215, in one embodiment, to generate the ranked reciprocal mutuality scores RRM precision method 200 first obtains similarity scores for the unique pairings of source artefact and target artefact. The scores may be obtained by loading the scores from a pre-calculated similarity matrix, or by calculating the scores on the fly during processing. In one embodiment, the ranked reciprocal mutuality analysis is, advantageously, agnostic toward the algorithm used to score similarity, provided that one similarity scoring algorithm is used consistently for the various pairings. Therefore, in one embodiment, the RRM precision method 200 may be used to determine match precision based on practically any numerical measure of similarity.

Thus, a wide variety of similarity metrics may be used with RRM precision method 200. In one embodiment, the similarity of pairs is scored by cosine similarity, which uses the cosine of the angle between the vectors for the source artefact and the target artefact as the similarity score. In one embodiment, the similarity of pairs is scored by Euclidean distance, which uses the straight-line distance between the vectors for the source artefact and the target artefact as the similarity score. In one embodiment, the similarity of pairs is scored by Manhattan distance (also known as city-block distance or L1 distance), which uses the sum of absolute differences between corresponding coordinates of the vectors for the source artefact and the target artefact as the similarity score. In one embodiment, the similarity of pairs is scored by Pearson correlation coefficient, which uses a measure of linear correlation between the vectors for the source artefact and the target artefact as the similarity score. In one embodiment, the similarity of pairs is scored by earth mover's distance, which uses a measure of work to transform the vector for the source artefact into the vector for the target artefact as the similarity score. Other numerical measures of similarity between vector-embedded data artefacts may also be appropriate.

Then, RRM precision method 200 sorts various subsets of the pairings by similarity score. For example, for each source artefact, RRM precision method 200 sorts the pairings of the source artefact with multiple (or all) target artefacts in descending order of similarity score. And, for each target artefact, RRM precision method 200 sorts the pairings of the target artefact with multiple (or all) source artefacts in descending order of similarity score.

From the sorted similarity sources, RRM precision method 200 identifies the ranks of the pairing of source artefact and target artefact among (i) the sorted pairings with multiple target artefacts (“alpha rank” or “alpha score”), and (ii) the sorted pairings with multiple source artefacts (‘beta rank” or “beta score”). In one embodiment, RRM precision method 200 determines the alpha and beta ranks for each source-target artefact pairing. For example, to determine the alpha rank of a given pairing of source artefact and target artefact (am,bn), RRM precision method 200 accesses the pairings of the source artifact am with all target artefacts as sorted in descending order of similarity score, and then identifies the rank position (alpha) of the pairing of source artefact am with target artefact bn among the sorted pairings of source artefact am with all target artefacts. And, to determine the beta rank of the given pairing (am,bn), RRM precision method accesses the pairings of the target artifact bn with all source artefacts as sorted in descending order of similarity score, and then identifies the rank position (beta) of the pairing of source artefact am with target artefact bn among the sorted pairings of all source artefacts with target artefact bn. In this way, RRM precision method 200 determines the reciprocal rank of similarity for both artefacts.

RRM precision method 200 then generates the ranked reciprocal mutuality score (or sigma score) based on the alpha and beta scores. For example, RRM precision method 200 combines the alpha and beta scores into a single numerical value for the sigma score. In one embodiment, the sigma score for a given pairing is the sum of the alpha and beta scores for the pairing, less 1 for convenience of downstream processing. Subtracting 1 ensures that the lowest possible value for the sigma score is one, rather than two. However, in one embodiment, subtraction of 1 is not necessary, provided adjustment are made (for example to the sigma threshold) to allow for a minimum value of two for sigma. In one embodiment, RRM precision method 200 determines sigma scores for a plurality of source-target artefact pairs, or for each source-target artefact pair.

The RRM precision method 200 then stores the sigma scores for the source-target artefact pairs. For example, the scores may be stored in a data structure that associates the scores with their respective source-target artefact pair.

In one embodiment, the steps of block 215 are performed by RRM score generator 110. At the conclusion of block 215, RRM precision method 200 has generated ranked reciprocal mutuality (sigma) score(s) for one or more source-target artefact pairs. The sigma score(s) enable pairs of artefacts to be evaluated with respect to reciprocity (precision), rather than by similarity alone, thereby establishing an extent of mutual equivalence between the paired artefacts. Processing continues to block 220.

At block 220, RRM precision method 200 retains the pairings that have a ranked reciprocal mutuality score that satisfies a threshold. And, in one embodiment, RRM precision method 200 discards the pairings that have a ranked reciprocal mutuality score that does not satisfy the threshold. In one embodiment, the threshold may be a cutoff or cap C on ranked reciprocal mutuality score for pairings, as discussed in further detail below. And, in one embodiment, the threshold is a quantity F of top-ranked pairings in terms of ranked reciprocal mutuality score, as discussed in further detail below.

In one embodiment, a pairing satisfies the threshold by being below a cutoff or cap C on ranked reciprocal mutuality score. For example, where, the cap C=3, all of the pairings that have a ranked reciprocal mutuality score greater than 3 will be filtered out and discarded, while those of the pairings that have a ranked reciprocal mutuality score of 3 or less will be retained. Note, the where, C=3, the alpha and beta ranks are constrained to be 3 or less and to add up to no more than 4, requiring that the pairing never be more than a third rank match for either artefact. It is possible here that no pairings will satisfy the cap on RRM (sigma) score C, thereby preventing finding any pairing to be a match where artefacts are insufficiently equivalent. The conditions of the threshold may be recorded as a Boolean logic statement that includes a variable for the RRM score. For example the logic statement may compare the value of RRM score for the pairing to cap C. Here, the threshold is satisfied where the value of RRM score for the pairing is less than or equal to cap C, and the threshold is not satisfied where the value of RRM score for the pairing is greater than cap C. (E.g., Threshold_Satisfied=RRM_Score≤C).

In one embodiment, a pairing satisfies the threshold by being within a top few F pairings (or even the single top pairing (F=1)) based on ranked reciprocal mutuality score. For example, with F=1, RRM precision method 200 selects a pairing of the source artefact and the target artefact to be a best match over the other pairings. The selection is based on the ranked reciprocal mutuality score indicating that the pairing has greater reciprocity (precision) than other pairings that have similarity scores greater than a similarity score of the pairing. Thus, in one embodiment, this ensures that there will always be at least F most equivalent pairings to choose from, even when the equivalence is low. The conditions of the threshold may be recorded as a Boolean logic statement that includes a variable for the RRM rank. For example, the logic statement may compare the number of top pairings F to a rank of the pairing in terms of RRM score. RRM precision method 200 first sorts the pairings by RRM score to determine their respective ranks in terms of RRM score, then evaluates the logic statement. Here, the threshold is satisfied where the rank is less than or equal to F, and the threshold is not satisfied where the rank is greater than F. (E.g., Threshold_Satisfied=RRM_Rank≤F).

In either case, in one embodiment, the RRM precision method 200 accesses a pre-configured definition for the threshold, such as an applicable one of the logic statements above that expresses the conditions of the threshold. For the one or more (or each) of the pairings being evaluated against the threshold, RRM precision method 200 populates the logic statement with a variable value that corresponds to the pairing, and executes the logic statement to determine whether or not the pairing satisfies the threshold. In one embodiment, the status of whether the pairings satisfy the threshold is recorded for subsequent reference. For example, the pairings that satisfy the threshold are so labeled, for example by setting a flag in a data structure describing the pairing to indicate that the threshold is satisfied. And, the pairings that do not satisfy the threshold are also labeled, for example by setting the flag to indicate that the threshold is not satisfied.

In one embodiment, the steps of block 220 are performed by pairing filter 115. At the conclusion of block 220, RRM precision method 200 has generated a set of pairings that satisfy a threshold that differentiates pairings that are sufficiently precise to be considered a match from pairings that are only superficially similar. Processing continues to block 225.

At block 225, RRM precision method 200 generates an electronic alert that indicates the remaining pairings to be most equivalent matches. In one embodiment, RRM precision method 200 generates the electronic alert based on the pairings that satisfy the threshold, such as the pairings that are considered to be best match, and/or top few most equivalent pairings. In one embodiment, RRM precision method 200 generates the electronic alert by composing and transmitting a computer-readable message including content that reports the pairing(s) that are most equivalent or best matches. In one embodiment, RRM precision method 200 accesses a template electronic alert message from memory or storage. RRM precision method 200 then populates the content of the electronic alert message. The content may include a listing of the pairings that satisfy the threshold. The content may also include a further listing of the pairings that do not satisfy the threshold. The content may also include identifiers for the source dataset and for the target dataset. The content may further include one or more of similarity scores, RRM (sigma) scores, alpha scores, and beta scores, that correspond to the pairings.

Once the electronic alert message is composed, RRM precision method 200 transmits the electronic alert message to downstream components. The electronic alert message may be configured for processing by downstream clients that consume determinations of matched pairs of artefacts, for subsequent presentation on a display in a GUI or CLI, to trigger the initiation of an action, or for other action. In one embodiment, the steps of block 225 are performed by alert generator 120. At the conclusion of block 225, RRM precision method 200 proceeds to end block 230 where RRM precision method 200 concludes.

In one embodiment, a variety of actions may be automatically initiated in response to a determination that artefact pairings satisfy the threshold for being a match. For example: (1) in a use case of matching text segments for update, (such as for the human language security framework described herein), the system may automatically adopt the a newer or more recent one of the artefacts (text segment) as the current value for the text; (2) in a use case of data deduplication, the system may automatically combine the matched source and target artifacts into a single, unified artefact, and/or notify users or administrators of potentially duplicate content; (3) in a use case of data enrichment, the system may automatically add details from one artefact of the matched pair to another, for example enhancing user profiles or item descriptions; (4) in a use case of fraud detection or security alerting, the system may automatically trigger security protocols where the matched artefacts describe user activity and a profile of activity deemed suspicious, respectively (the security protocols may include generation of fraud alerts, locking of accounts or data access, or initiation of further verification or investigation processes); (5) in a use case of compliance or regulatory reporting, the system may automatically trigger compliance protocols where the matched artefacts describe activity and a profile of activity that is regulated, respectively (the compliance protocols may include updating compliance records, generating regulatory reports and filings, or initiating compliance checks); (6) in a use case of machine vision and navigation, the system may automatically trigger hazard avoidance of a moving robot where the matched artefacts are a current image of an environment in which the robot is navigating and an image of an obstacle, respectively.

In an advantageous improvement over automatic initiation based on similarity score alone, automatic initiation based on RRM score provides increased accuracy of the automatic initiation, reducing false alarms. In another advantageous improvement, the automatic initiation based on RRM score is performed with significantly lowered computing requirements for determining precise matches, rendering it highly appropriate to mobile computing systems with limited compute resources such as autonomous vehicles and robots.

In one embodiment, as a recap, RRM precision method 200 loads a source dataset containing source artefacts and a target dataset containing target artefacts into the RRM precision system 100, thereby initializing the datasets. In one embodiment, where the artefacts in the dataset are not previously embedded, the RRM precision method 200 converts all source and target artefacts into their numerical vector representations using a pre-selected embedding model. In one embodiment, where similarities between unique pairings of artefacts are not previously calculated, RRM precision method 200 calculates the similarity scores between the paired artefacts using a pre-selected similarity calculator (such as cosine similarity). RRM precision method 200 then ranks the similarity scores for each source artefact against a plurality of target artefacts (e.g., all target artefacts, or K target artefacts including the target artefact paired with the source artefact) in descending order. RRM precision method 200 then assigns alpha scores: For each source-target pair, RRM precision method 200 assigns an alpha score based on the rank position of the target artefact's similarity to the source artefact. RRM precision method 200 then fetches reciprocal similarities, for each target artefact retrieving and ranking a plurality of source artefacts by similarity score to the target artefact. RRM precision method 200 then assigns beta scores: For each source-target pair, RRM precision method 200 assigns a beta score based on the rank position of the source artefact's similarity to the target artefact. RRM precision method 200 then calculates the sigma scores for each source-target pair by summing the alpha and beta scores for the pair, and subtracting one. RRM precision method 200 stores the alpha, beta, and sigma scores for each source-target pair in a data structure for subsequent analysis. RRM precision method 200 applies a threshold to the sigma scores to filter out less precise matches, retaining the pairs with the most equivalent relationships. RRM precision method 200 then outputs the filtered list of source-target pairs along with their similarity and mutual-reciprocal scores.

### —Further Features of RRM Precision Method—

In one embodiment, RRM precision method 200 generates a ranked reciprocal mutuality score for a pairing of a source artefact and a target artefact (discussed above at block 215) by performing steps to determine reciprocal ranks of similarity score for each of the source artefact and the target artefact. RRM precision method 200 determines an alpha rank of the target artefact among the other target artefacts for similarity to the source artefact based on the similarity scores for pairings of the source artefact with the target artefact and other target artefacts. RRM precision method 200 also determines a beta rank of the source artefact among the other source artefacts for similarity to the target artefact based on the similarity scores for pairings of the target artefact with the source artefact and other source artefacts. And, RRM precision method 200 combine the alpha rank and the beta rank to generate the ranked reciprocal mutuality score.

In one embodiment, generation of a ranked reciprocal mutuality score for a pairing of a source artefact and a target artefact by RRM precision method 200 (discussed above at block 215) includes particular steps for generating the ranked reciprocal mutuality score from similarity scores of multiple pairings. RRM precision method 200 determines a set of unique ordered pairs of one of the source artefacts and one of the target artefacts. RRM precision method 200 generates the similarity scores for the ordered pairs. The similarity score for an ordered pair is measured between the source artefact in the ordered pair and the target artefact in the ordered pair. For a current pair (or in one embodiment, multiple pairs, or in another embodiment, all pairs) in the set of ordered pairs, RRM precision method 200 performs the following steps. RRM precision method 200 sorts, in descending order of similarity score, those of the ordered pairs that include a current source artefact that is in the current pair. RRM precision method 200 determines an alpha rank position for the current pair among the sorted ordered pairs that include the current source artefact. RRM precision method 200 sorts, in descending order of similarity score, those of the ordered pairs that include a current target artefact that is in the current pair. RRM precision method 200 determines a beta rank position for the current pair among the sorted ordered pairs that include the current target artefact. And, RRM precision method 200 generates the ranked reciprocal mutuality score for the current pair based on combining the alpha rank position and the beta rank position.

In one embodiment, generation of ranked reciprocal mutuality score is based on evaluating K nearest (most similar) neighbor artefact pairs, rather than all artefact pairs. For example, RRM precision method 200 determines a top K target artefacts in the target database for similarity to the source artefact. Here, the set including the target artefact and the other target artefacts (discussed at block 215) are the top K target artefacts. And, RRM precision method 200 determines a top K source artefacts in the source database for similarity to the target artefact. Here, the set including the source artefact and the other source artefacts (discussed at block 215) are the top K source artefacts. In one embodiment, as discussed below, K has a value between 2 and 10.

In one embodiment, RRM precision method 200 further operates to determine best (most equivalent, rather than just most similar) text matches between a source document and a target document. In this example, the source document is a human language security framework, and the target document is another human language document, such as another security framework. In one embodiment, the source artefacts and target artefacts are vector-embedded passages of text that describe a requirement, action, or process in one or more human language security frameworks. Accordingly, in one embodiment RRM precision method 200 further parses one or more human language security frameworks to extract passages of text that serve as descriptions of a requirement, action, or process. In one embodiment, the parsing may be performed by using regular expressions to identify the passages of text for extraction. RRM precision method 200 then generates the plurality of source artefacts and the plurality of target artefacts from the extracted passages of text. For example, the RRM precision method 200 converts the extracted passages of text into vector representations of the passages using an embedding model. And, RRM precision method 200 populates the source dataset with the plurality of source artefacts (generated from the passages of text) and populates the target dataset with the plurality of target artefacts.

In one embodiment, the source artefacts and target artefacts are vector embeddings of data objects. For example, the source artefacts and target artefacts may be embedded passages of text, images, audio, video, graphs, nodes, or other data entities.

In one embodiment, generating the ranked reciprocal mutuality score includes, for the individual pairings of source artefact and target artefact, performing the following steps: (1) generate an alpha rank of a similarity score for the individual pairing among a set of pairings of the source artefact with the plurality of the target artefacts; (2) generate a beta rank of the similarity score for the individual pairing among a set of pairings of the target artefact among the plurality of the source artefacts; and (3) combine the alpha rank and the beta rank to generate the ranked reciprocal mutuality score for the individual pairing.

In one embodiment, generating the ranked reciprocal mutuality score includes, for the individual pairings of source artefact and target artefact, performing the following steps: (1) determine a top K target artefacts in the target database for similarity to the source artefact; (2) generate an alpha rank of a similarity score for the individual pairing among a set of pairings of the source artefact with the top K target artefacts; (3) determine a top K source artefacts in the source database for similarity to the target artefact; (4) generate a beta rank of the similarity score for the individual pairing among a set of pairings of the target artefact with the top K source artefacts; and (5) combine the alpha rank and the beta rank to generate the ranked reciprocal mutuality score for the individual pairing.

In one embodiment, the ranked reciprocal mutuality scores provide a measure of reciprocity (precision)—based on measures of similarity—that is agnostic to the type of similarity measure employed. Therefore, in one embodiment, wherein the ranked reciprocal mutuality scores for the pairings are able to be generated from similarity scores calculated for the pairings using any of cosine similarity, Euclidean distance, Manhattan distance, Pearson correlation coefficient, or earth mover's distance.

In one embodiment, ranked reciprocal mutuality scores are generated for all unique pairings of the source artefacts with the target artefacts.

In one embodiment, RRM precision method 200 generates the ranked reciprocal mutuality scores from the similarity scores by using only basic mathematical and logical operations of the processor on similarity scores.

In one embodiment, RRM precision method 200 generates the ranked reciprocal mutuality scores for all unique pairings of the source artefacts with the target artefacts. For example, RRM precision method 200 may find the Cartesian product of source dataset A and target dataset B to generate all unique pairings of the source artefacts with the target artefacts, execute a similarity analysis of the pairings using a chosen similarity metric, thereby populating a similarity matrix for source dataset A and target dataset B, and then generating the ranked reciprocal mutuality scores (as discussed above) for all the unique pairings.

In one embodiment, the threshold (discussed in block 220) is a cap on the ranked reciprocal mutuality score. In one embodiment, the threshold is a quantity of top-ranked pairings in terms of ranked reciprocal mutuality score.

### —Context and Discussion of RRM Precision—

Embedding models convert data artefacts such as human-language texts, images, audio, video, graphs, nodes or other structured data, and other information, as well as multimodal combinations thereof, into numerical vectors. Examples of embedding models include, but are not limited to, Word2Vec, GloVe, FastText, GPT, VGG, ResNet, Inception, CLIP, Wave2Vec, VGGish, MFCC, Node2Vec, VisuaIBERT.

Embedding models permit the similarity of two artefacts (a,b) to be computed where the similarity of artefact a to artefact b (similarity(a,b)) is the equal to the similarity of artefact b to artefact a (similarity(b,a)). Where a collection or collections of artefact similarities exist it is possible to compute similarities for various artefact pairings (a,b), (a,c), (b,c) and so on. Similarity scores alone permit discovery of artefacts with strong similarities to an artefact of interest, but the similarity score alone does not permit for easy determination of strongest—that is, most relevant or equivalent—relationships within a set. The measure of strength, relevance, or equivalence of a relationship of a pair of artefacts is referred to herein as reciprocity (precision).

For example, when a collection of artefacts is large the artefact with strongest similarity to artefact a may be artefact b. But, artefact b may have a far stronger similarity to artefact c, meaning the similarity between artefacts a and b may be less relevant (or not relevant at all) when the presence of artefact c is known. In another example, in collection of data artefacts describing animals, the artefact with strongest similarity to a Pekingese dog may be a Persian cat, but the Persian cat in turn may have a stronger similarity to a tabby cat than to the Pekingese dog.

This mechanism-ranked reciprocal mutuality-uses the ranked similarities of artefact a and the ranked similarities of potential similar artefacts (b, c, d, . . . ) to provide a measure of reciprocity (precision) for the selection of most-similar matches within a collection of artefacts. In other words, the RRM precision system implements a reciprocity (precision) mechanism for the selection of most equivalent artefacts within a large set of calculated artefact similarities. In one embodiment, the RRM precision system provides tunable, reliable, and data-agnostic reciprocity (precision) analysis using only data computed for simple similarity which already exists, and without dataset specific filters.

The RRM precision system improves over matching systems that evaluate similarity alone, by re-analyzing existing similarity data to produce a measure of reciprocity (precision) for candidate matches. In particular, matching using the RRM precision system is more robust and reliable than matching based on similarity alone, because the mutuality-based decisioning employed by the RRM precision system protects against a situation in which minor changes to one artefact, or removal, addition, or replacement of one artefact to a dataset produce substantially different outcomes.

The RRM precision system improves over existing matching systems by establishing a threshold (such as a cap) on a score for RRM precision score (referred to herein as a sigma score) as discussed herein below.

The RRM precision system demonstrates improved reliability because the matches are established deterministically. This renders the process fully repeatable: in the event of data loss, were the vector embeddings of the datasets recomputed using the same model, the RRM precision system will provide duplicate results with the recomputed data.

Further, the RRM precision system improves over existing matching systems by making a determination about the reciprocity (precision) of a given match using the embedded, vectorized form of the artefacts, without referring to the unembedded artefacts.

In one example application, the RRM precision system may be used to determine most equivalent sentences within a large set of published security frameworks. Applying the RRM precision system causes the resulting identifications of the most equivalent sentences to meet or exceed the quality achieved by manual analysis of the security frameworks.

In one embodiment, in the use case of matching text segments, an artefact may be a textual description of a requirement, action, or process which is small enough for the generation of an embedding, it is a component of a larger body of artefacts. For instance, artefact examples might be:
SPS00-53: Audit and Accountability: AU-4: Audit Log Storage Capacity: Allocate audit log storage capacity to accommodate [Assignment: organization-defined audit log retention requirements].
Critical Security Controls: Audit Log Management: S.3: Ensure Adequate Audit Log Storage: Ensure that logging destinations maintain adequate storage to comply with the enterprises audit log management process.
Cloud Controls Matrix: Identity & Access Management: IAM-05: Least Privilege: Employ the least privilege principle when implementing information system access.

In an example overview of operations by one embodiment, the RRM precision system operates to determine the most relevant—i.e., most precise—pairing among artefacts, given the similarities between the artefacts.

Given a set of calculated similarities between pairings of artefacts a, b, and c: (a,b) similarity=0.5, (a,c) similarity=0.4, (b,c) similarity=0.7, it is known that artefact a is most similar to artefact b, however artefact b is more strongly similar to artefact c.

Applying a score that is based on rank of similarities (also referred to as a rank-based score) for artefacts a and b (similarity 0.5):

$$\begin{matrix}( a , b ) = 1 st rank match ( ( a , b ) > ( a , c ) ) \\ ( b , a ) = 2 nd rank match ( ( a , b ) < ( b , c ) ) \\ Mutuality = 1 + 2 = 3\end{matrix}$$

Applying a rank-based score between similarities for artefacts a and c (similarity 0.4):

$$\begin{matrix}( a , c ) = 2 nd rank match ( ( a , c ) > ( a , b ) ) \\ ( c , a ) = 2 nd rank match ( ( a , c ) < ( b , c ) ) \\ Mutuality = 2 + 2 = 4\end{matrix}$$

Applying a rank-based score between similarities for artefacts b and c (similarity 0.7):

$$\begin{matrix}( b , c ) = 1 st rank match ( ( b , c ) > ( a , b ) ) \\ ( c , b ) = 1 st rank match ( ( b , c ) > ( a , c ) ) \\ Mutuality = 1 + 1 = 2\end{matrix}$$

The resulting mutuality scores can then be used to set a threshold to discard similarity-based matches which are weak within the overall set of matches. If mutuality is filtered by being constrained to be less than or equal to 2, then only those pairs which share or reciprocate 1^{st} rank similarity (b,c) will be selected. If mutuality is filtered to be constrained to be less than or equal to 3, then only those pairs which share or reciprocate a 1^{st} or a 1st and 2^{nd}-ranked similarity will be selected ((b,c) and (a,b)).

Thus, advantageously, the RRM precision systems and methods described herein uses data calculated for similarity—namely, the similarity values for the various parings of artefacts—for the purposes of determining reciprocity (precision). This method of determining reciprocity (precision) of a pair match based on similarity is advantageously lightweight in its use of compute resources: the RRM precision method implements the precision determination using basic mathematical and logical operations. Moreover, the reciprocity (precision) is determined in a data agnostic way. For example, the reciprocity (precision) is determined using numerical similarity, and without reference to the underlying, unembedded artefact data.

In one embodiment, basic functionality of the RRM precision system operates as follows. The RRM precision system performs an outer loop that iterates through pairings of one source artefact am belonging to a source collection A with a plurality of N target artefacts b1 through bN that are included in a target collection B of artefacts. For each of the N target artefacts, the RRM precision system performs the following steps for a target artefact bn under consideration for the iteration: (1) increment an alpha score for the pairing of source artefact am with target artefact bn to increase the alpha score by 1; (2) initialize a beta score for the pairing of source artefact am with target artefact bn to zero; (3) fetch similarities for the pairings of target artefact bn with source artefacts a1 through aM that are included in the source collection A; (4) re-order (i.e., sort) the similarities for the pairings of target artefact bn with source artefacts a1 through aM in descending order of similarity from greatest similarity score to least similarity score; and (5) perform an inner loop that iterate through the sorted pairings of target artefact bn with source artefacts a1 through aM until a reciprocal similarity is found. (Note, in one embodiment, there will be only one bn-am reciprocal similarity.)

In the inner loop, for each of the M source artefacts, the RRM precision system performs the following steps for a source artefact an under consideration for the iteration: (a) increment the beta score for the pairing of source artefact am with target artefact bn to increase the beta score by 1; (b) check whether the beta-th similarity of target artefact bn is with the alpha-th similarity of source artefact am; (c) where preceding condition in (b) above is true, no further source-target pairs will exist, so the current artefacts an and bn, the alpha and beta scores, and the similarity score for the current pairing (an,bn) are stored for subsequent processing; and (d) calculate a sigma score for combined mutuality rank of the current pairing (an,bn) by summing alpha and beta, and subtracting 1. Note, the sigma score stores mutuality −1 for ease of post process filtering.

In one embodiment, the outer loop may also be repeated more than one time, for example for each of the M embedded artefacts a1 through aM that are included in the source collection A.

In one embodiment, the artefacts under consideration by the RRM precision system are embedded vector representations of an unembedded data object for the artefact. In one embodiment, the RRM precision method has pre-calculated the similarities of a given artefact to the other artefacts, and pre-sorted these similarities in descending order of similarity.

### —Example RRM Precision Method Using Pre-Computed Similarities—

In one embodiment, the RRM precision method may be configured to operate using a database of pre-computed similarities between datasets. For example, the RRM precision method acts on a pair of datasets of artefacts (A, B) as follows in steps (1) and (2) below. For reference to discussion elsewhere herein, dataset A may be considered the “source” dataset, with the artefacts included therein considered “source” artefacts; and dataset B may be considered the “target” dataset, with the artefacts included therein considered “target” artefacts.
(1) The RRM precision method generates a Cartesian product of the artefact sets A and B to return a set of ordered pairs (tuples) formed by taking an element from each of sets A and B. More formally, as shown in EQ. 1:

$$A \times B = \{ ( a , b ) \vert a ∈ A and b ∈ B \} \qquad EQ . 1$$

the Cartesian product of sets A and B includes the possible combinations where the first element comes from set A and the second element comes from set B. The RRM precision method thus produces the Cartesian product set (a1,b1), . . . , (a1,bn), . . . , (a1,bN), . . . , (am,b1), . . . , (am,bn), . . . , (am,bN), . . . , (aM,b1), . . . , (aM,bn), . . . , (aM,bN), where Mis the size of set A and N is the size of set B. In one embodiment, the RRM precision method pre-populates a similarity matrix S, as shown in EQ. 2:

$$S = [ \begin{matrix}{S}_{a 1 , b 1} & … & {S}_{a 1 , b n} & … & {S}_{a 1 , b N} \\ ⋮ & ⋱ & ⋮ & & ⋮ \\ {S}_{a m , b 1} & … & {S}_{a m , b n} & … & {S}_{a m , b N} \\ ⋮ & & ⋮ & ⋱ & ⋮ \\ {S}_{a M , b 1} & … & {S}_{a M , b n} & … & {S}_{a M , b N}\end{matrix} ] \qquad EQ . 2$$

And, RRM precision method stores the populated similarity matrix S as a data structure. In one embodiment, the RRM precision method accesses a pre-populated similarity matrix S.
(2) The RRM precision method then iterates through an analysis of the cartesian products in turn, as follows in steps (a) through (c). (a) For a given pair of interest, e.g., (am,bn), the RRM precision method (i) ranks first similarity scores (am,b1) through (am,bN) from highest to lowest; (ii) locates a first rank position of a first similarity score for the given pair of interest within the ranked first similarity scores—the first rank position is designated the “alpha” score α; and (iii) stores the alpha score α of the given pairing for subsequent processing. (b) Similarly, for the given pair of interest (am,bn), the RRM precision method (i) ranks second similarity scores for (a1,bn) through (aM,bn) from highest to lowest; (ii) locates a second rank position of a second similarity score for the given pair of interest—the second rank position is designated the “beta” score β; and (iii) stores the beta score β of the given pairing for subsequent processing. (c) The RRM precision method then (i) generates a mutual-reciprocal score, designated the “sigma” score σ, for example by summing the alpha and beta scores and subtracting 1 to produce the sigma score (σ=α+β−1); and (ii) stores sigma score σ for subsequent processing.

In one embodiment, the mutual-reciprocal “sigma” score σ is stored in a data structure in association with the given pair of interest for which the score was generated. For example, the sigma score σ is stored in association with the corresponding similarity value in the data structure that stores the similarity matrix S. In one embodiment, the alpha score α and beta score β generated for the given pair of interest may also be stored in association with the with the given pair of interest and their associated similarity and sigma score σ values. For example, a table or other data structure may be indexed by the pair values (am,bn), and store at the indexed locations an array (or other data structure) of data for the pairing of artefacts am and bm (am,bn), including: (1) a similarity of artefact am to artefact bn (S_{am,bn}), (2) an alpha score for the pairing of artefacts am and bm α_{am,bn}, that is, a rank of similarity of artefact am to artefact bn with respect to similarities of artefact am to artefacts b1 through bN; (3) a beta score for the pairing of artefacts am and bm β_{am,bn}, that is, a rank of similarity of artefact bn to artefact am with respect to similarities of artefact bn to artefacts a1 through aM; and (5) a sigma score for the pairing of artefacts am and bn σ_{am,bn}, that is, a value of mutual reciprocity of similarities between the paired artefacts am and bn.

In this way, the unique pairings of artefacts/entities between sets A and B are provided with a similarity score and a mutual-reciprocal score. Both of these scores can be used to filter the pairings of interest to retain the most precise—that is, most equivalent—pairings.

### —Example RRM Precision Method Using Nearest-Neighbor Search—

In one embodiment, the RRM precision method may be configured to operate using nearest-neighbor searches in lieu of pre-computed (m,n) similarity scores. For example, where a nearest-neighbor search is used, such as, for example, where set B is a subset of a larger set, the RRM precision method iterates through artefacts belonging to a first dataset A in a pair of datasets (A,B), for example for artefact am from values of am from a1 through aM, performing steps (a) through (c) below for individual artefacts.

(a) The RRM precision method retrieves K nearest neighbors to am within the second set B as a list ranked by similarity. (b) The RRM precision method generates a Cartesian product of the artefact set am and the retrieved K nearest neighbors from set B, as shown in EQ. 3:

$$a n \times KNN ( B ) = \{ ( a n , b ) \vert b ∈ KNN ( B ) \} \qquad EQ . 3$$

producing the nearest neighbor Cartesian product set for artefact am (am,b1), (am,bk), . . . , (am,bK), where K is number of nearest neighbors and the size of set KNN(B).

(c) The RRM precision method then iterates through the list of unique pairings of the nearest neighbor Cartesian product set (am,bk) for values of bk from b1 through BK in the ranked order of similarity, performing actions (i) through (iv) as follows. (i) The RRM precision method stores a current rank position for the pairing (am,bk) in the list as the “alpha” score α_{am,bk} for the pairing (am,bk). (ii) The RRM precision method retrieves the K nearest neighbors to bk within the first set A as a list ranked by similarity. (iii) If am exists (is included) in the retrieved set of K nearest neighbors to bk, the RRM precision method locates the rank position of am among the list of K nearest neighbors to bk and stores it as the beta score β_{am,bk} for the pairing (am,bk). And, (iv) if the beta score β_{am,bk} exists, the RRM precision method calculates the mutual-reciprocal (sigma) score σ_{am,bk} for the pairing (am,bk), σ_{am,bk}=α_{am,bk}+β_{am,bk}−1, and stores the sigma score σ_{am,bk} for the pairing (am,bk), and optionally storing α_{am,bk} and β_{am,bk} also. In one embodiment, the alpha, beta, and sigma scores are stored in a data structure as described above for Pre-Computed Similarities.

In one embodiment, the K target artefacts are included in a target collection B. In one embodiment, the K target artefacts are included in a subset of source collection A that excludes the current source artefact under consideration am. The value of K is determinative of how far down in the ranks of similarity a match may be considered for greater reciprocity (precision). In one embodiment, K is at least two, to allow for a second ranked pairing to be determined to be a more precise match. More generally, higher values of K allow for lower-ranked pairings to be analyzed as potentially more precise matches. In one embodiment, the value of K may be a tunable value that is pre-set by a user or administrator of the RRM precision system. K may be tuned to be more, or fewer objects based on the particular application. There are diminishing returns for increases to the value of K, with values of K beyond 10 being useful where there is little variation in similarity between various pairings, or where sets are very large. Thus, there is no hard cutoff of utility for the value of K. In one embodiment, values of K between 4 and 8, for example K=5, have yielded satisfactory results. In one embodiment, the value of K may be tunable to meet performance-related objectives.

In this way, again, the unique pairings of artefacts/entities between sets A and B are provided with a similarity score and a mutual-reciprocal score, where the mutual-reciprocal score is less than or equal to the number of nearest neighbors (σ_{am,bk}≤K). As above, both of the similarity and mutual-reciprocal scores can be used to filter the pairings of interest to retain the most precise—that is, most equivalent—pairings. Thus, in one embodiment, the RRM precision method not limited to using a dense similarity matrix as shown above, and, in one improvement, is instead extensible to a sparse, nearest neighbor similarity matrix that can be more processor and memory efficient than the dense similarity matrix.

### —Example Operation of RRM Precision Method—

FIG. 4 illustrates one example of results 400 of applying an RRM precision method to two datasets, dataset A 405 and dataset B 410. Example results 400 shows how performing the operations of an RRM precision method (such as method 200 above) serves to remove or filter out of the pairings of interest those pairings that are relatively low in reciprocity (precision), while retaining those pairings that are relatively high in reciprocity (precision).

As discussed above, the RRM precision method operates to determine the most similar pairings between dataset A 405 and dataset B 410. As above, dataset A 405 includes M total artefacts, and dataset B 410 includes N total artefacts. Results 400 show the individual artefacts of a given set to be associated with up to K total similar artefacts of the other set, with the associations sorted in descending order similarity value. In one embodiment, K may be a total of nearest neighbors. In one embodiment, K may be less than or equal to N for artefacts in dataset A 405, and K may be less than or equal to M for artefacts in dataset B 410.

Analysis based on similarity value alone would determine that artefact a1 415 is most similar to artefact b1 420, as shown by #1 similarity 425 of artefact a1 415. The similarity of artefact a1 415 to artefact b1 420 is first-ranked for artefact a1, yielding for the pairing (a1,b1) an alpha score α_{a1,b1}=1.

However, analysis based on similarity value alone provides less accurate results due to imprecise matching. Here, artefact b1 420 has a stronger similarity to artefact a2 430 than to artefact a1 415, as shown by #1 similarity 435 of artefact b1 420 and #3 similarity 440 of artefact b1 420. The similarity of artefact b1 420 to artefact a1 415 ranks only third in the set of K entities in dataset A 405 that artefact b1 420 is similar to. Because the similarity of artefact a1 415 to artefact b1 420 is third-ranked for artefact b1 420, the pairing (a1,b1) is assigned a beta score β_{a1,b1}=3. And, because the similarity of artefact a2 430 to artefact b1 420 is first-ranked for artefact b1, the pairing (a2,b1) is assigned a beta score β_{a2,b1}=1.

Furthermore, artefact a2 430 also has strongest similarity to artefact b1, as shown by #1 similarity 445 of artefact a2 430. Because the similarity of artefact a2 430 to artefact b1 420 is first-ranked for artefact a2, the pairing (a2,b1) is assigned an alpha score α_{a2,b1}=1.

The sigma scores for the pairings (a1,b1) and (a2,b1) are determined based on the respective alpha and beta scores for these two pairings. The pairing (a1,b1) is assigned a sigma score σ_{a1,b1}=α_{a1,b1}+β_{a1,b1}−1=1+3−1=3. The pairing (a2,b1) is assigned a sigma score σ_{a2,b1}=α_{a2,b1}+β_{a2,b1}−1=1+1−1=1. Note that lower sigma score values for mutual-reciprocal rank indicate better or greater precedence than higher sigma score values. Therefore, although the pairing (a1,b1) has a greater overall similarity value, the pairing (a2,b1) has a better mutual-reciprocal rank than the pairing (a1,b1). So, the pairing (a1,b1) may potentially be discarded in favor of the pairing (a2,b1), thus increasing the reciprocity (precision) of similarity in the retained results.

As discussed above, the foregoing RRM precision analysis may repeat for the second-ranked #2 similarity 450 of artefact a1 415, and so on through the similarities of the various artefacts belonging to dataset A 405. For example, second-ranked #2 similarity 450 indicates that artefact a1 415 has a second strongest similarity to artefact b3 455. Because the similarity of artefact a1 415 to artefact b3 455 is second-ranked for artefact a1 415, the pairing (a1,b3) is assigned an alpha score α_{a1,b3}=2. And, first-ranked #1 similarity 460 of artefact b3 455 indicates that artefact b3 455 is most strongly similar to artefact a1 415. Because the similarity of artefact a1 415 to artefact b3 455 is first-ranked for artefact b3 455, the pairing (a1,b3) is assigned a beta score β_{a1,b3}=1. The RRM precision analysis then generates the mutual-reciprocal sigma score σ_{a1,b3}=α_{a1,b3}+β_{a1,b3}−1=2+1−1=2.

Therefore, the pairing (a1,b3) has a better mutual-reciprocal rank σ_{a1,b3}=2 than the pairing (a1,b1) (σ_{a1,b1}=3), but a worse mutual-reciprocal rank than the pairing (a2,b1) (σ_{a2,b1}=1). Accordingly, the most precise pairing for artefact a1 415 in set B 410 (so far) is with artefact b3 455, even though the similarity 450 between artefact a1 415 and artefact b3 455 is lower than the similarity 425 between artefact a1 415 and artefact b1 420.

### —Cloud or Enterprise Embodiments—

In one embodiment, the present system (such as RRM precision system 100) is a computing/data processing system including a computing application or collection of distributed computing applications for access and use by other client computing devices that communicate with the present system over a network. In one embodiment, RRM precision system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, RRM precision system 100 is a centralized server-side application that provides at least the functions disclosed herein and that is accessed by many users by way of computing devices/terminals communicating with the computers of RRM precision system 100 (functioning as one or more servers) over a computer network. In one embodiment RRM precision system 100 may be implemented by a server or other computing device configured with hardware and software to implement the functions and features described herein.

In one embodiment, the components of RRM precision system 100 may be implemented as sets of one or more software modules executed by one or more computing devices specially configured for such execution. In one embodiment, the components of RRM precision system 100 are implemented on one or more hardware computing devices or hosts interconnected by a data network. For example, the components of RRM precision system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of RRM precision system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of RRM precision system 100 may (i) generate or compose an electronic message or signal to issue a command or request to another component, (ii) transmit the message or signal to other components of RRM precision system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by RRM precision system 100, for example through a web interface server. In one embodiment, the remote computing system may send requests to and receive responses from RRM precision system 100. In one example, access to the information or applications may be effected through use of a web browser on a personal computer or mobile device. In one example, communications exchanged with RRM precision system 100 may take the form of remote representational state transfer (REST) requests using JavaScript object notation (JSON) as the data interchange format for example, or simple object access protocol (SOAP) requests to and from XML servers. The REST or SOAP requests may include API calls to components of RRM precision system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or the logic described herein.

### —Computing Device Embodiment—

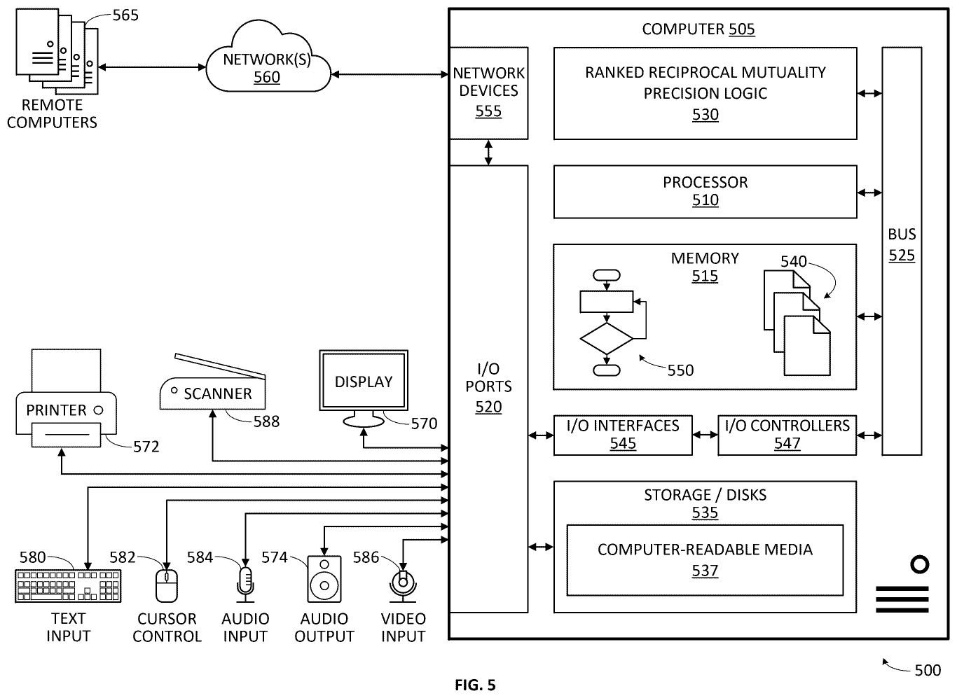

FIG. 5 illustrates an example computing system 500 that is configured and/or programmed as a special purpose computing device(s) with one or more of the example systems and methods described herein, and/or equivalents. The example computing device may be a computer 505 that includes at least one hardware processor 510, a memory 515, and input/output ports 520 operably connected by a bus 525. In one example, the computer 505 may include ranked reciprocal mutuality (RRM) precision logic 530 configured to facilitate use of ranked reciprocal mutuality as a reciprocity (precision) mechanism for sets of similarities, similar to the methods, systems, logic or other embodiments shown and described with reference to FIGS. 1, 2, 3, and 4.

In different examples, the logic 530 may be implemented in hardware, one or more non-transitory computer-readable media 537 with stored instructions, firmware, and/or combinations thereof. While the logic 530 is illustrated as a hardware component attached to the bus 525, it is to be appreciated that in other embodiments, the logic 530 could be implemented in the processor 510, stored in memory 515, or stored in disk 535.

In one embodiment, logic 530 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate use of ranked reciprocal mutuality as a reciprocity (precision) mechanism for sets of similarities. The means may also be implemented as stored computer executable instructions that are presented to computer 505 as data 540 that are temporarily stored in memory 515 and then executed by processor 510.

Logic 530 may also provide means (e.g., hardware, non-transitory computer-readable medium that stores executable instructions, firmware) for performing one or more of the disclosed functions and/or combinations of the functions.

Generally describing an example configuration of the computer 505, the processor 510 may be a variety of various processors including dual microprocessor and other multi-processor architectures. A memory 515 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 535 may be operably connected to the computer 505 via, for example, an input/output (I/O) interface (e.g., card, device) 545 and an input/output port 520 that are controlled by at least an input/output (I/O) controller 547. The disk 535 may be, for example, a magnetic disk drive, a solid-state drive, a floppy disk drive, a tape drive, a Zip drive, a flash memory card, a memory stick, and so on. Furthermore, the disk 535 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 515 can store a process 550 and/or a data 540, for example. The disk 535 and/or the memory 515 can store an operating system that controls and allocates resources of the computer 505.

The computer 505 may interact with, control, and/or be controlled by input/output (I/O) devices via the input/output (I/O) controller 547, the I/O interfaces 545, and the input/output ports 520. Input/output devices may include, for example, one or more network devices 555, displays 570, printers 572 (such as inkjet, laser, or 3D printers), audio output devices 574 (such as speakers or headphones), text input devices 580 (such as keyboards), cursor control devices 582 for pointing and selection inputs (such as mice, trackballs, touch screens, joysticks, pointing sticks, electronic styluses, electronic pen tablets), audio input devices 584 (such as microphones or external audio players), video input devices 586 (such as video and still cameras, or external video players), image scanners 588, video cards (not shown), disks 535, and so on. The input/output ports 520 may include, for example, serial ports, parallel ports, and USB ports.

The computer 505 can operate in a network environment and thus may be connected to the network devices 555 via the I/O interfaces 545, and/or the I/O ports 520. Through the network devices 555, the computer 505 may interact with a network 560. Through the network 560, the computer 505 may be logically connected to remote computers 565. Networks with which the computer 505 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

1. One or more non-transitory computer-readable media that include stored thereon computer-executable instructions that, when executed by at least a processor of a computing system cause the computing system to:
access a source dataset that includes a plurality of source artefacts and a target dataset that includes a plurality of target artefacts, wherein the source artefacts and target artefacts are vector embeddings that represent one or more of a text, an image, an audio, or a video;
generate a ranked reciprocal mutuality score that quantifies precision of a pairing of a source artefact and a target artefact, wherein the ranked reciprocal mutuality score is generated by:
(A) generating first similarity scores between pairs of the vector embeddings that correspond to pairings of the source artefact with the target artefact and other target artefacts;
(B) generating second similarity scores between pairs of the vector embeddings that correspond to pairings of the target artefact with the source artefact and other source artefacts; and
(C) arithmetically combine an alpha rank of the target artefact in the first similarity scores and a beta rank of the source artefact in the second similarity scores to generate the ranked reciprocal mutuality score;
select the pairing of the source artefact and the target artefact to be a best match over other pairings based on the ranked reciprocal mutuality score; and
generate an electronic alert that indicates the pairing to be the best match.

2. The non-transitory computer-readable media of claim 1, wherein the computer-executable instructions to generate a ranked reciprocal mutuality score for a pairing of a source artefact and a target artefact further cause the computing system to:
determine the alpha rank of the target artefact among the other target artefacts for similarity to the source artefact based on the first similarity scores for pairings of the source artefact with the target artefact and other target artefacts;
determine the beta rank of the source artefact among the other source artefacts for similarity to the target artefact based on the second similarity scores for pairings of the target artefact with the source artefact and other source artefacts; and
combine the alpha rank and the beta rank to generate the ranked reciprocal mutuality score.

3. The non-transitory computer-readable media of claim 1, wherein the computer-executable instructions to generate a ranked reciprocal mutuality score for a pairing of a source artefact and a target artefact further cause the computing system to:
determine a set of ordered pairs of one of the source artefacts and one of the target artefacts, wherein the first similarity score or second similarity score for an ordered pair is measured between the source artefact in the ordered pair and the target artefact in the ordered pair;
for a current pair in the set of ordered pairs, (i) sort, in descending order of similarity score, those of the ordered pairs that include a current source artefact that is in the current pair, (ii) determine the alpha rank position for the current pair among the sorted ordered pairs that include the current source artefact, (iii) sort, in descending order of similarity score, those of the ordered pairs that include a current target artefact that is in the current pair, (iv) determine the beta rank position for the current pair among the sorted ordered pairs that include the current target artefact, and (v) generate the ranked reciprocal mutuality score for the current pair based on combining the alpha rank position and the beta rank position.

4. The non-transitory computer-readable media of claim 1, wherein the computer-executable instructions further cause the computing system to:
determine a top K target artefacts in the target dataset for similarity to the source artefact, wherein the target artefact and the other target artefacts are the top K target artefacts; and
determine a top K source artefacts in the source dataset for similarity to the target artefact, wherein the source artefact and the other source artefacts are the top K source artefacts.

5. The non-transitory computer-readable media of claim 4, wherein K has a value between 2 and 10.

6. The non-transitory computer-readable media of claim 1, wherein the computer-executable instructions further cause the computing system to:
parse one or more human language security frameworks to extract passages of text that serve as descriptions of a requirement, action, or process;
generate the plurality of source artefacts and the plurality of target artefacts from the extracted passages of text; and
populate the source dataset with the plurality of source artefacts and populate the target dataset with the plurality of target artefacts.

7. (canceled)

8. A computer-implemented method, comprising:
accessing a source dataset that includes a plurality of source artefacts and a target dataset that includes a plurality of target artefacts, wherein the source artefacts and target artefacts are vector embeddings that represent one or more of a text, an image, an audio, or a video;
generating, for pairings of the source artefacts with the target artefacts, ranked reciprocal mutuality scores that quantify precision of an individual pairing of a source artefact and a target artefact, wherein the ranked reciprocal mutuality scores are generated by:
(A) generating first similarity scores between pairs of the vector embeddings that correspond to pairings of the source artefact with the target artefact and other target artefacts;
(B) generating second similarity scores between pairs of the vector embeddings that correspond to pairings of the target artefact with the source artefact and other source artefacts; and
(C) arithmetically combine an alpha rank of the target artefact in the first similarity scores and a beta rank of the source artefact in the second similarity scores to generate the ranked reciprocal mutuality score;
filtering the pairings to retain the pairings that have a ranked reciprocal mutuality score that satisfies a threshold; and
generating an electronic alert that indicates the remaining pairings to be most equivalent matches.

9. The computer-implemented method of claim 8, wherein generating the ranked reciprocal mutuality scores further comprises, for the individual pairings:
generating the alpha rank of a similarity score for the individual pairing among the pairings of the source artefact with the plurality of the target artefacts;
generating the beta rank of the similarity score for the individual pairing among the pairings of the target artefact among the plurality of the source artefacts; and
combining the alpha rank and the beta rank to generate the ranked reciprocal mutuality score for the individual pairing.

10. The computer-implemented method of claim 8, wherein generating the ranked reciprocal mutuality score further comprises, for the individual pairings:
determining a top K target artefacts in the target dataset for similarity to the source artefact;
generating an alpha rank of a similarity score for the individual pairing among a set of pairings of the source artefact with the top K target artefacts;
determining a top K source artefacts in the source dataset for similarity to the target artefact;
generating a beta rank of the similarity score for the individual pairing among a set of pairings of the target artefact with the top K source artefacts; and
combining the alpha rank and the beta rank to generate the ranked reciprocal mutuality score for the individual pairing.

11. The computer-implemented method of claim 8, wherein the ranked reciprocal mutuality scores for the pairings are able to be generated from similarity scores calculated for the pairings using any of cosine similarity, Euclidean distance, Manhattan distance, Pearson correlation coefficient, or earth mover's distance.

12. The computer-implemented method of claim 8, wherein ranked reciprocal mutuality scores are generated for all unique pairings of the source artefacts with the target artefacts.

13. The computer-implemented method of claim 8, wherein the threshold is a cap on the ranked reciprocal mutuality score.

14. The computer-implemented method of claim 8, wherein the threshold is a quantity of top-ranked pairings in terms of ranked reciprocal mutuality score.

15. A computing system, comprising:
at least one processor connected to at least one memory;
one or more non-transitory computer-readable media that include stored thereon computer-executable instructions that, when executed by the processor and memory of the computing system cause the computing system to:
access a source dataset that includes a plurality of source artefacts and a target dataset that includes a plurality of target artefacts, wherein the source artefacts and target artefacts are vector embeddings that represent one or more of a text, an image, an audio, or a video;
generate, for pairings of the source artefacts with the target artefacts, ranked reciprocal mutuality scores that quantify precision of an individual pairing of a source artefact and a target artefact, wherein the ranked reciprocal mutuality scores are generated by:
(A) generating first similarity scores between pairs of the vector embeddings that correspond to pairings of the source artefact with the target artefact and other target artefacts;
(B) generating second similarity scores between pairs of the vector embeddings that correspond to pairings of the target artefact with the source artefact and other source artefacts; and
(C) arithmetically combine an alpha rank of the target artefact in the first similarity scores and a beta rank of the source artefact in the second similarity scores to generate the ranked reciprocal mutuality score;
discard the pairings that have a ranked reciprocal mutuality score that do not satisfy a threshold; and
generate an electronic alert that indicates the remaining pairings to be most equivalent matches.

16. The computing system of claim 15, wherein the computer-executable instructions further cause the computing system to:
generate the alpha rank of a similarity score for the individual pairing among a set of pairings of the source artefact with the plurality of the target artefacts;
generate the beta rank of the similarity score for the individual pairing among a set of pairings of the target artefact among the plurality of the source artefacts; and
combine the alpha rank and the beta rank to generate the ranked reciprocal mutuality score for the individual pairing.

17. The computing system of claim 15, wherein the computer-executable instructions further cause the computing system to:
determining a top K target artefacts in the target dataset for similarity to the source artefact;
generating an alpha rank of a similarity score for the individual pairing among a set of pairings of the source artefact with the top K target artefacts;
determining a top K source artefacts in the source dataset for similarity to the target artefact;
generating a beta rank of the similarity score for the individual pairing among a set of pairings of the target artefact with the top K source artefacts; and
combining the alpha rank and the beta rank to generate the ranked reciprocal mutuality score for the individual pairing.

18. The computing system of claim 15, wherein the computer-executable instructions further cause the computing system to generate the ranked reciprocal mutuality scores using operations of the processor selected from the set consisting of addition, subtraction, logical AND, logical OR, logical NOT, and sort on a plurality of the similarity scores for the pairings of the source artefact with the target artefact and other target artefacts and for pairings of the target artefact with the source artefact and other source artefacts.

19. The computing system of claim 15, wherein the computer-executable instructions further cause the computing system to:
parse one or more human language security frameworks to extract passages of text that serve as descriptions of a requirement, action, or process;
generate the plurality of source artefacts and the plurality of target artefacts from the extracted passages of text, wherein the generation includes embedding the source artefacts and target artefacts in vectors; and
populate the source dataset with the plurality of source artefacts and populate the target dataset with the plurality of target artefacts.

20. The computing system of claim 15, wherein the computer-executable instructions further cause the computing system to generate the ranked reciprocal mutuality scores for all unique pairings of the source artefacts with the target artefacts.
